(19) United States
(12) Patent Application Publication
(10) Pub. No.: US 2019/0104560 A1
(43) Pub. Date: Apr. 4, 2019

(54) Method of Data Recovery with Uplink Switching

(71) Applicant: MediaTek Singapore Pte. Ltd., Singapore (SG)

(72) Inventor: Pavan Santhana Krishna Nuggehalli, San Jose, CA (US)

(21) Appl. No.: 16/149,968

(22) Filed: Oct. 2, 2018

Related U.S. Application Data
(60) Provisional application No. 62/566,800, filed on Oct. 2, 2017.

(51) Int. Cl. H04W 76/15; H04W 76/34; H04L 29/06

(52) U.S. Cl. CPC H04W 76/15; H04L 69/22; H04W 76/34

(57) ABSTRACT

A method of data recovery with uplink switching for dual connectivity (DC) is proposed. A UE establishes two data radio bearers for simultaneous data transmission under DC. When the UE receives a command to switch from using two paths to using a single path for uplink transmission, packets that have been pre-processed by the RLC entity on the “deactivated” leg are retransmitted by a transmitting PDCP entity to the RLC entity for the “active” leg. The transmitting PDCP entity performs retransmission of certain unsent PDCP PDUs that are previously submitted to the RLC entity that is now deactivated, and retransmits to the RLC entity that is still active. The unsent PDCP PDUs are defined as those PDCP PDUs that have been pre-processed by the deactivated RLC entity but have either not been transmitted at all or the successful delivery has not been confirmed by the lower layers.

### CROSS REFERENCE TO RELATED APPLICATIONS

This application claims priority under 35 U.S.C. § 119 from U.S. Provisional Application No. 62/566,800 entitled “Data Recovery with Uplink Switching” filed on Oct. 2, 2017, the subject matter of which is incorporated herein by reference.

### TECHNICAL FIELD

The disclosed embodiments relate generally to wireless communication, and, more particularly, to data recovery with uplink switching for UEs with dual-connectivity.

### BACKGROUND

Mobile data usage has been increasing at an exponential rate in recent year. A Long-Term Evolution (LTE) system offers high peak data rates, low latency, improved system capacity, and low operating cost resulting from simplified network architecture. In LTE systems, an evolved universal terrestrial radio access network (E-UTRAN) includes a plurality of base stations, such as evolved Node-B's (eNBs) communicating with a plurality of mobile stations referred as user equipment (UEs). Due to the steep increase in mobile traffic over the past years, there have been many attempts in finding new communication technologies to further improve the end-use experience and system performance of the mobile networks. The traffic growth has been mainly driven by the explosion in the number of connected derives, which are demanding more and more high-quality content that requires very high throughput rates.

The Dual Connectivity (DC) technology has been proposed in the LTE systems by 3GPP as one of the most relevant technologies to accomplish even higher per-user throughput and mobility robustness and load balancing. Given that a UE is configured with DC, it can be connected simultaneously to two eNodeBs: a master eNB (MeNB) and a secondary eNB (SeNB), which operate on different carrier frequencies and are interconnected by traditional backhaul links via X2 interface. These backhauls are non-ideal in practice, being characterized by a certain latency and limited capacity. DC has been exploited in a scenario with the integration between multiple Radio Access Technologies (RATs), where the MeNB belongs to one RAT and the SeNB belongs to another RAT.

From system architecture perspective, there is a split between the Control Plane and the User Plane. The Control Plane is responsible for transmitting system information and controlling the UE connectivity, and the User Plane handles UE specific data. The User Plane is composed by the following protocol layers: Service Data Adaptation Protocol (SDAP), Packet Data Convergence Protocol (PDCP), Radio Link Control (RLC), and Media Access Control (MAC). Based on different DC configuration, the User Plane data is split in the Core Network (CN) or in the MeNB. In wireless systems, upper layer Radio Resource Control (RRC) signaling is used to enable switching between split path and single path operation for DC. Unlike LTE, the next generation new radio (NR) supports preprocessing wherein some or all packet headers for SDAP, PDCP, RLC, and MAC are computed prior to reception of an uplink grant. Under this situation, there is potential for packet loss if the network switches the UE from using two paths to a single path for uplink transmission. A solution to address this problem is needed.

### SUMMARY

A method of data recovery with uplink switching for dual connectivity (DC) is proposed. A UE establishes two data radio bearers for simultaneous data transmission under DC. When the UE receives a command to switch from using two paths to using a single path for uplink transmission, packets that have been pre-processed by the RLC entity on the “deactivated” leg are retransmitted by a transmitting PDCP entity to the RLC entity for the “active” leg. The transmitting PDCP entity performs retransmission of certain unsent PDCP PDUs that are previously submitted to the RLC entity that is now deactivated, and retransmits to the RLC entity that is still active. The unsent PDCP PDUs are defined as those PDCP PDUs that have been pre-processed by the deactivated RLC entity but have either not been transmitted at all or the successful delivery has not been confirmed by the lower layers.

In one embodiment, a UE establishes a first data radio bearer (DRB) with a first base station and a second DRB with a second base station for simultaneous data transmission under dual connectivity in a wireless communication network. The UE routes a first plurality of Packet Data Convergence Protocol (PDCP) PDUs from a PDCP entity to a first radio link control (RLC) entity associated with the first DRB and routes a second plurality of PDCP PDUs from the PDCP entity to a second RLC entity associated with the second DRB. The UE receives a configuration from the network that configures the UE to deactivate the second data radio bearer for data transmission. The UE retransmits a subset of PDCP PDUs of the second plurality of PDCP PDUs to the first RLC entity. In one embodiment, the PDCP entity sends a request to the second RLC entity for sending back the subset of PDCP PDUs that has been pre-processed by the second RLC entity but either has not been submitted to a lower entity or has not been successfully transmitted to the network by the lower entity.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with a user equipment (UE) supporting Dual Connectivity (DC) in accordance with embodiments of the current invention.

FIG. 2 illustrates simplified block diagram of network entities supporting DC in accordance with embodiments of the current invention.

FIG. 3 illustrates one embodiment of handling data recovery with uplink switching in accordance with embodiments of the current invention.

FIG. 4 illustrates a sequence flow between a UE PDCP entity, a first RLC entity, a second RLC entity for data recovery with uplink switching in accordance with one novel aspect.

FIG. 5 is a flow chart of a method of data recovery with uplink switching from UE perspective in accordance with one novel aspect.

### DETAILED DESCRIPTION

Reference will now be made in detail to some embodiments of the invention, examples of which are illustrated in the accompanying drawings.

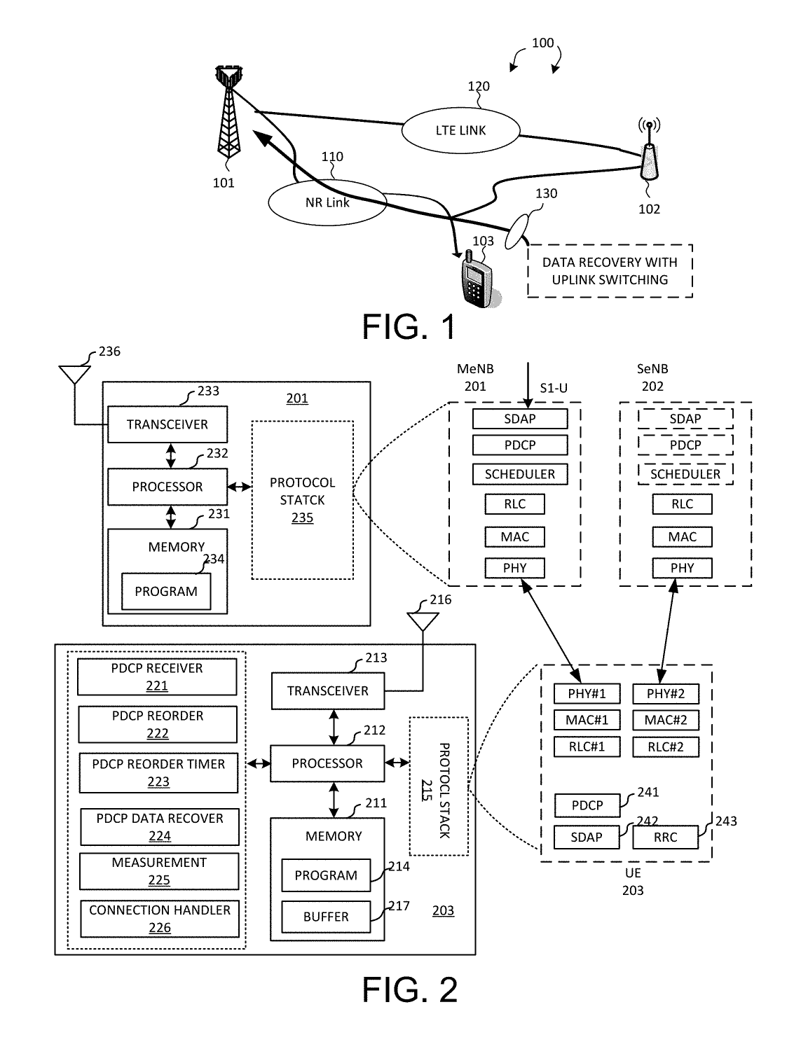

FIG. 1 illustrates a system diagram of a wireless network 100 with a user equipment (UE) supporting Dual Connectivity (DC) in accordance with embodiments of the current invention. Wireless network 100 comprises a first base station BS 101, a second base station BS 102, and a user equipment UE 103 configured with Dual Connectivity (DuCo or DC). Under DuCo, UE 103 can be connected simultaneously to two eNodeBs: a master eNB (MeNB) and a secondary eNB (SeNB), which operate on different carrier frequencies and are interconnected by traditional backhaul links via X2 interface. These backhauls are non-ideal in practice, being characterized by a certain latency and limited capacity. The group of serving cells associated with MeNB and the SeNB is termed as master cell group (MC) and secondary cell group (SCG), respectively. DC is only applicable to UEs in Radio Resource Control (RRC) connected mode. A DC-enabled UE has two identities: one cell radio network temporary identifier (C-RNTI) in the MCG and another C-RNTI in the SCG.

DC has been exploited in a scenario with the integration between multiple Radio Access Technologies (RATs), where the MeNB belongs to one RAT and the SeNB belongs to another RAT. In one example, BS 101 is a 5G base station (gNodeB) that provides 5G New Radio (NR) cellular radio access via 5G radio access network (RAN); and BS 102 is a 4G base station (eNodeB) that provides 4G LTE radio access via E-UTRAN. In one example, gNodeB 101 is an MeNB and eNodeB 102 is an SeNB. In other examples, both base stations can be 5G base stations (gNodeBs) or 4G base stations (eNodeBs).

In the example of FIG. 1, IP packets are carried between a serving gateway and MeNB 101 over the S1-U interface. MeNB 101 performs Packet Data Convergence Protocol (PDCP) layer operations such as ciphering and header compression (ROHC). In addition, MeNB 101 is responsible for aggregating data flows over the NR and LTE air-interfaces. For example, the PDCP entity of the MeNB 101 performs traffic splitting, floor control, and new PDCP header handling for IP packets received from the serving gateway. In the downlink, MeNB 101 can schedule a few PDCP PDUs over NR access and the remaining over LTE access. The PDCP entity of the DuCo UE 103 buffers the PDCP PDUs received over NR and LTE air interfaces and performs appropriate functions such as traffic converging and reordering, new PDCP header handling, and legacy PDCP operation. Similar functionality is also required for the uplink. In 5G NR, a new Service Data Adaptation Protocol (SDAP) layer is introduced to provide mapping between a QoS flow and a data radio bearer, and marking QoS flow in both downlink and uplink packets.

From system architecture perspective, there is a split between the Control Plane and the User Plane. The Control Plane is responsible for transmitting system information and controlling the UE connectivity, and the User Plane handles UE specific data. The User Plane is composed by the following protocol layers: Service Data Adaptation Protocol (SDAP), Packet Data Convergence Protocol (PDCP), Radio Link Control (RLC), and Media Access Control (MAC). Based on different DuCo configuration, the User Plane data is split in the Core Network (CN) or in the RAN with or without bearer split in the RAN. From UE perspective, UE can establish two radio bearers with the network: one radio bearer with MeNB and one radio bearer with SeNB. For realizing the DC solution, split bearers (radio bearers served by both MeNB and SeNB) in the uplink can be supported.

For a split bearer, the network can configure a split bearer to transmit on both paths or on a single path. In cellular networks, upper layer Radio Resource Control (RRC) signaling is used to enable switching between split bearers and single bearer operation for DC. Unlike LTE, NR system supports packet preprocessing wherein some or all packet headers for SDAP, PDCP, RLC, and MAC are computed prior to reception of an uplink grant. Under this situation, there is potential for packet loss if the network switches the UE from using two paths to a single path for uplink transmission.

In accordance with a novel aspect, when UE receives a command to switch from using two paths to using a single path for uplink transmission, packets that have been pre-processed on the “deactivated” leg are retransmitted by PDCP to the RLC entity for the “active” leg. Specifically, when a transmitting PDCP entity associated with two RLC entities is configured via RRC signaling to submit PDCP PDUs to a single configured RLC entity, then the transmitting PDCP should perform retransmission of certain PDCP Data PDUs previously submitted to the deactivated RLC entity—the certain PDUs refer to all of the PDCP Data PDUs whose successful delivery has not been confirmed by lower layers, or has been pre-processed by the deactivated RLC entity but has not been submitted to lower layers.

FIG. 2 illustrates simplified block diagrams for MeNB 201, SeNB 202, and UE 203. UE 203 has radio frequency (RF) transceiver module 213, coupled with antenna 216 receives RF signals from antenna 216, converts them to baseband signals and sends them to processor 212. RF transceiver 213 also converts received baseband signals from the processor 212, converts them to RF signals, and sends out to antenna 216. Processor 212 processes the received baseband signals and invokes different functional modules to perform features in UE 203. Memory 211 stores program instructions and data 214 and buffer 217 to control the operations of UE 203.

UE 203 also includes multiple function modules and circuits that carry out different tasks in accordance with embodiments of the current invention. UE 203 includes a PDCP receiver 221, a PDCP reordering handler 222, a PDCP reordering timer 223, a PDCP data recovery module 224, a measurement module 225, and a connection handling circuit 226. PDCP receiver 221 receives one or more PDCP protocol data units (PDUs) from lower layers. PDCP reordering module 222 performs a timer-based PDCP reordering process upon detecting a PDCP gap condition. PDCP reordering timer 223 starts a reordering timer when detecting the PDCP gap existing condition and detecting no reordering timer running. PDCP data recovery module 224 retransmits packets under certain condition to prevent unnecessary data loss and/or PDCP serial number SN gaps. Measurement module 225 measures target PDUs. Connection handling circuit 226 handles connection and data radio bearer establishment with the serving base stations.

Similarly, FIG. 2 shows an exemplary block diagram for MeNB 201. MeNB 201 has RF transceiver module 233, coupled with antenna 236 receives RF signals from antenna 236, converts them to baseband signals and sends them to processor 232. RF transceiver 233 also converts received baseband signals from the processor 232, converts them to RF signals, and sends out to antenna 236. Processor 232 processes the received baseband signals and invokes different functional modules to perform features in eNB 201. Memory 233 stores program instructions and data 234 to control the operations of eNB 201. A protocol stack 235 performs enhanced protocol stack task in accordance to embodiments of the current invention.

FIG. 2 also shows that UE 203 connects with both MeNB 201 and SeNB 202 under DuCo configuration. In protocol stack 235, MeNB 201 has a PHY layer, a MAC layer, an RLC layer, a scheduler, a PDCP layer, and a SDAP layer. In protocol stack 215, UE 203 has a PHY #1 layer, a MAC #1 layer, and an RLC #1 layer that connect with MeNB 201. UE 203 also has a PHY #2 layer, a MAC #2 layer, and an RLC #2 layer that connect with SeNB 202. UE 203 has a PDCP layer entity 241, an SDAP layer entity 242, and an RRC layer entity 243. PDCP layer circuit handles sequence numbering, header compression and decompression, transfer of user data, reordering, PDCP PDU routing, PDCP SDU retransmission, ciphering and deciphering, PDCP SDU discard, PDCP re-establishment and data recovery for RLC, PDCP PDU duplication, and the split bearer from the MeNB and the SeNB. SDAP layer entity 242 performs mapping between a QoS flow and a data radio bearer, and marking QoS flow in both DL and UL packets for new NR QoS framework. At the UE, a single SDAP is configured for each individual PDU session. UE 203 aggregates its data traffic with MeNB 201 and SeNB 202. For DuCo, both the MeNB data traffic and the SeNB data traffic are aggregated at the PDCP layer entity of UE 203. RRC layer entity 243 receives higher layer configuration information from the network via the Master Base Station.

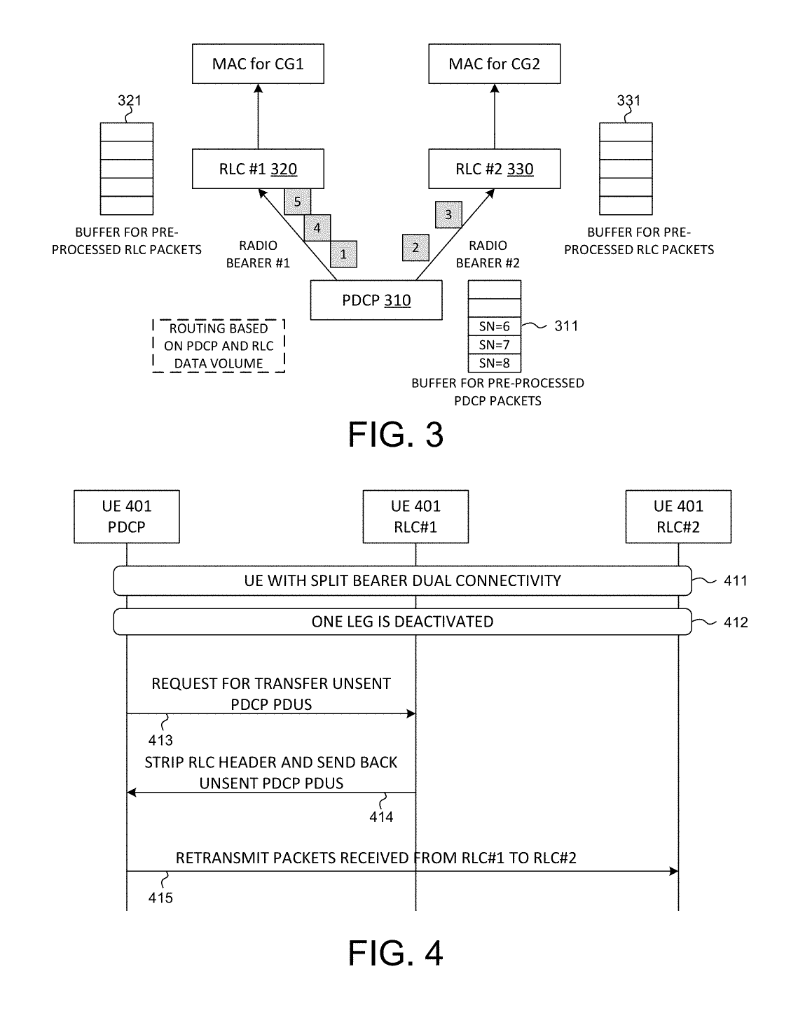

FIG. 3 illustrates one embodiment of handling data recovery with uplink switching in accordance with embodiments of the current invention. In the embodiment of FIG. 3, a UE comprises a PDCP entity 310, a first RLC entity RLC #1 320 and a first MAC layer for a first cell group CG #1 served by an MeNB, a second RLC entity RLC #2 330 and a second MAC layer for a second cell group CG #2 served by an SeNB. The PDCP entity 310 is associated with a PDCP buffer 311 for pre-processed PDCP packets, and RLC entities 320 and 330 are associated with corresponding RLC buffers (321 and 331) for pre-processed RLC packets. PDCP packets routing is based on PDCP and RLC data volume, and thresholds can be set by the MeNB and configured through RRC signaling.

In one example, the UE is connected to both the MeNB via a radio bearer #1 and the SeNB via radio bearer #2 under DuCo configuration. Initially, for uplink, the PDCP entity of the UE has a series of PDCP packets to be routed to the network. The PDCP entity first pre-processes the PDCP packets and saved in the PDCP buffer. Under DuCo, different PDCP packets are routed to either MeNB or SeNB based on PDCP and RLC data volume. For example, PDCP packets with SN #1, #4 and #5 are routed to MeNB via RLC #1, and PDCP packets with SN #2 and #3 are routed to SeNB via RLC #2. The RLC entities receive the PDCP packets, add RLC headers, pre-process the RLC packets, and save the RLC packets in the RLC buffers. The RLC entities then forward the RLC packets to the MAC entities accordingly for subsequent processing.

For a split bearer, the network can configure a split bearer to transmit and receive data packets on both paths or on a single path. In NR systems, upper layer Radio Resource Control (RRC) signaling is used to enable switching between split bearers and single bearer operation for DC. For example, the network can deactivate radio bearer #2 for the UE via RRC signaling. That is, the UE PDCP entity associated with RLC #1 and RLC #2 is configured via RRC signaling to route all PDCP PDUs to a single configured RLC entity, e.g., RLC #1. When UE receives an RRC command to switch from using two paths to using a single path for uplink transmission, packets that have been pre-processed on the “deactivated” leg (e.g., RLC #2) are retransmitted by PDCP to the RLC entity for the “active” leg (e.g., RLC #1). In one example, the PDCP entity performs retransmission of PDCP PDUs previously submitted to the deactivated leg RLC #2 that has been pre-processed by RLC #2 but has not been successfully delivered yet, and these PDCP PDUs will be retransmitted by the PDCP entity to the active leg RLC #1 to prevent unnecessary data loss and/or PDCP SN gaps.

FIG. 4 illustrates a sequence flow between a UE PDCP entity, a first RLC entity, a second RLC entity for data recovery with uplink switching in accordance with one novel aspect. In step 411, UE 401 is configured with split bearer dual connectivity, and its PDCP entity is connected to two RLC entities RLC #1 and RLC #2. The PDCP entity processes PDCP PDUs and routes different PDCP PDUs to RLC #1 or RLC #2 based on routing policy determined by the PDCP and RLC data volume. In step 412, UE 401 receives RRC signaling to deactivate one of the data paths that is routed via RLC #1. At this point, RLC #1 has already pre-processed some RLC packets, however, these RLC packets has not been successfully sent to the network yet by the lower layers. As a result of deactivating of RLC #1, those RLC packets may become lost packets. In step 413, the PDCP entity sends a request to RLC #1 for transfer those unsent PDCP PDUs. In step 414, RLC #1 strips the RLC header of the pre-processed RLC packets and sends the unsent PDCP PDUs back to the PDCP entity. Note that RLC #1 applies RLC acknowledgement mode (RLC-AM) and sends the unsent PDCP PDUs in an ascending order of associated COUNT values. In step 415, the PDCP entity retransmit these unsent PDCP PDUs received from RLC #1 to RLC #2. The unsent PDCP PDUs will then be processed by RLC #2 and transmitted to the network without being lost.

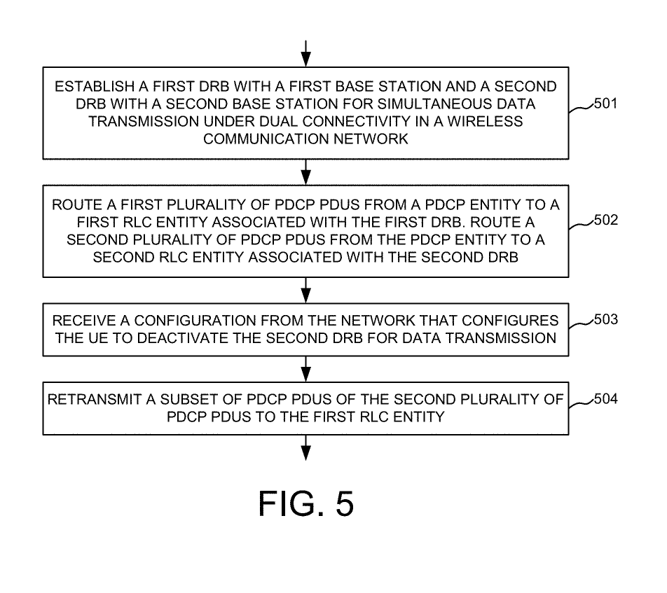

FIG. 5 is a flow chart of a method of data recovery with uplink switching from UE perspective in accordance with one novel aspect. In step 501, a UE establishes a first data radio bearer (DRB) with a first base station and a second DRB with a second base station for simultaneous data transmission under dual connectivity in a wireless communication network. In step 502, the UE routes a first plurality of Packet Data Convergence Protocol (PDCP) PDUs from a PDCP entity to a first radio link control (RLC) entity associated with the first DRB and routes a second plurality of PDCP PDUs from the PDCP entity to a second RLC entity associated with the second DRB. In step 503, the UE receives a configuration from the network that configures the UE to deactivate the second data radio bearer for data transmission. In step 504, the UE retransmits a subset of PDCP PDUs of the second plurality of PDCP PDUs to the first RLC entity. In one embodiment, the PDCP entity sends a request to the second RLC entity for sending back the subset of PDCP PDUs that has been pre-processed by the second RLC entity but either not submitted to a lower entity or not successfully transmitted to the network by the lower entity.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a first data radio bearer (DRB) with a first base station and a second DRB with a second base station by a user equipment (UE) for simultaneous data transmission under dual connectivity in a wireless communication network;
routing a first plurality of Packet Data Convergence Protocol (PDCP) PDUs from a PDCP entity to a first radio link control (RLC) entity associated with the first DRB and routing a second plurality of PDCP PDUs from the PDCP entity to a second RLC entity associated with the second DRB;
receiving a configuration from the network that configures the UE to deactivate the second data radio bearer for data transmission; and
retransmitting a subset of PDCP PDUs of the second plurality of PDCP PDUs to the first RLC entity.

2. The method of claim 1, wherein the subset of PDCP PDUs has been pre-processed by the second RLC entity to create a subset of RLC packets by adding RLC headers.

3. The method of claim 2, wherein the PDCP entity sends a request to the second RLC entity for sending back the subset of PDCP PDUs.

4. The method of claim 2, wherein the second RLC entity strips off the RLC headers of the subset of RLC packets to recreate the subset of PDCP PDUs.

5. The method of claim 2, wherein the subset of the PDCP PDUs has been submitted to a lower layer entity but a successful delivery has not been confirmed by the lower layer entity.

6. The method of claim 2, wherein the subset of the PDCP PDUs have not been submitted to a lower layer entity for transmission.

7. The method of claim 2, wherein the subset of the PDCP PDUs are first routed to the second RLC entity applying RLC acknowledged mode (RLC-AM) or RLC unacknowledged mode (RLC-UM) and retransmitted to the first RLC entity in an ascending order of associated count values.

8. The method of claim 1, wherein the configuration is received via a radio resource control (RRC) signaling message.

9. The method of claim 1, wherein the routing of the first plurality and the second plurality of PDCP PDUs is based on data volumes of the PDCP entity, the first RLC entity, and the second RLC entity.

10. A User Equipment (UE) comprising:
a data connection handling circuit that establishing a first data radio bearer (DRB) with a first base station and a second DRB with a second base station for simultaneous data transmission under dual connectivity in a wireless communication network;
a PDCP entity that routes a first plurality of Packet Data Convergence Protocol (PDCP) PDUs to a first radio link control (RLC) entity associated with the first DRB and routes a second plurality of PDCP PDUs to a second RLC entity associated with the second DRB; and
a receiver that receives a configuration from the network that configures the UE to deactivate the second data radio bearer for data transmission, wherein the PDCP entity retransmits a subset of PDCP PDUs of the second plurality of PDCP PDUs to the first RLC entity.

11. The UE of claim 10, wherein the subset of PDCP PDUs has been pre-processed by the second RLC entity to create a subset of RLC packets by adding RLC headers.

12. The UE of claim 11, wherein the PDCP entity sends a request to the second RLC entity for sending back the subset of PDCP PDUs.

13. The UE of claim 11, wherein the second RLC entity strips off the RLC headers of the subset of RLC packets to recreate the subset of PDCP PDUs.

14. The UE of claim 11, wherein the subset of the PDCP PDUs has been submitted to a lower layer entity but a successful delivery has not been confirmed by the lower layer entity.

15. The UE of claim 11, wherein the subset of the PDCP PDUs have not been submitted to a lower layer entity for transmission.

16. The UE of claim 11, wherein the subset of the PDCP PDUs are first routed to the second RLC entity applying RLC acknowledged mode (RLC-AM) or RLC unacknowledged mode (RLC-UM) and retransmitted to the first RLC entity in an ascending order of associated count values.

17. The UE of claim 10, wherein the configuration is received via a radio resource control (RRC) signaling message.

18. The UE of claim 10, wherein the routing of the first plurality and the second plurality of PDCP PDUs is based on data volumes of the PDCP entity, the first RLC entity, and the second RLC entity.
